(19) United States
(12) Patent Application Publication
(10) Pub. No.: US 2026/0282000 A1
(43) Pub. Date: Sep. 17, 2026

(54) BROADCAST INFORMATION PROCESSING METHOD AND APPARATUS, COMMUNICATION DEVICE, AND STORAGE MEDIUM

(71) Applicant: VIVO MOBILE COMMUNICATION CO., LTD., Dongguan (CN)

(72) Inventors: Dongru LI, Dongguan (CN); Kai WU, Dongguan (CN)

(21) Appl. No.: 19/676,861

(22) Filed: May 14, 2026

Related U.S. Application Data
(63) Continuation of application No. PCT/CN2024/131637, filed on Nov. 12, 2024.

(30) Foreign Application Priority Data
Nov. 16, 2023 (CN) 202311531540.8

(51) Int. Cl. H04W 72/0453; H04L 5/00; H04W 12/08; H04W 56/00; H04W 68/02; H04W 72/51

(52) U.S. Cl. CPC H04W 72/0453; H04L 5/0012; H04W 12/08; H04W 56/0015; H04W 68/02; H04W 72/51

(57) ABSTRACT

The present application discloses a broadcast information processing method, a broadcast information processing apparatus, a communication device, and a storage medium, and pertains to the field of communication technologies. The broadcast information processing method in embodiments of the present application includes: acquiring, by a first device, broadcast information; where the broadcast information is used to indicate at least one of the following: access control information; frequency domain location indication information of a synchronization raster or channel raster; inventory or paging monitoring indication information; frequency domain related information of ambient Internet of Things communication; and rate matching indication information.

### CROSS-REFERENCE TO RELATED APPLICATIONS

The present application is a continuation of International Patent Application No. PCT/CN2024/131637, filed on Nov. 12, 2024, which claims priority to the Chinese patent application with application No. 202311531540.8 and titled “BROADCAST INFORMATION PROCESSING METHOD AND APPARATUS, COMMUNICATION DEVICE, AND STORAGE MEDIUM” filed on Nov. 16, 2023, which are incorporated herein by reference in their entirety.

### TECHNICAL FIELD

The present application pertains to the field of communication technologies, and specifically relates to a broadcast information processing method, a broadcast information processing apparatus, a communication device, and a storage medium.

### BACKGROUND

In the Ambient Internet of Things (Ambient Internet of Things, AIoT), a read-write device, such as a reader (reader), usually needs to communicate with multiple ambient Internet of Things devices, such as tag devices (tag). An ambient Internet of Things device can establish a connection with a read-write device and communicate with the read-write device based on control instructions from the read-write devices.

### SUMMARY

Embodiments of the present application provide a broadcast information processing method, a broadcast information processing apparatus, a communication device, and a storage medium.

In a first aspect, a broadcast information processing method is provided, where the method includes:
acquiring, by a first device, broadcast information; where
the broadcast information is used to indicate at least one of the following:
access control information;
frequency domain location indication information of a synchronization raster or channel raster;
inventory or paging monitoring indication information;
frequency domain related information of ambient Internet of Things communication; and
rate matching indication information; where
the access control information includes at least one of the following:
cell access indication information, the cell access indication information being used to indicate whether access to a cell is allowed;
an indication of whether to acquire cell access indication information;
an indication of traffic types allowed in an access-permitted cell, the traffic types including device-originated traffic and/or device-terminated traffic;
an indication of device power classes allowed in an access-permitted cell; and
an indication of device types allowed in an access-permitted cell, the device types including at least one device type determined based on an energy storage capacity of an Internet of Things device and a capability of the IoT device to generate radio frequency signals for transmission; and
the frequency domain related information of the ambient Internet of Things communication includes at least one of the following:
an ambient Internet of Things communication bandwidth;
a frequency domain interval between ambient Internet of Things communication and non-ambient Internet of Things communication;
relative frequency domain starting location information of the ambient Internet of Things communication bandwidth; and
frequency hopping indication information of ambient Internet of Things communication.

In a second aspect, a broadcast information processing method is provided, where the method includes:
sending, by a second device, broadcast information; where
the broadcast information is used to indicate at least one of the following:
access control information;
frequency domain location indication information of a synchronization raster or channel raster;
inventory or paging monitoring indication information;
frequency domain related information of ambient Internet of Things communication; and
rate matching indication information; where
the access control information includes at least one of the following:
cell access indication information, the cell access indication information being used to indicate whether access to a cell is allowed;
an indication of whether to acquire cell access indication information;
an indication of traffic types allowed in an access-permitted cell, the traffic types including device-originated traffic and/or device-terminated traffic;
an indication of device power classes allowed in an access-permitted cell; and
an indication of device types allowed in an access-permitted cell, the device types including at least one device type determined based on an energy storage capacity of an Internet of Things device and a capability of the IoT device to generate radio frequency signals for transmission; and
the frequency domain related information of the ambient Internet of Things communication includes at least one of the following:
an ambient Internet of Things communication bandwidth;
a frequency domain interval between ambient Internet of Things communication and non-ambient Internet of Things communication;
relative frequency domain starting location information of the ambient Internet of Things communication bandwidth; and
frequency hopping indication information of ambient Internet of Things communication.

In a third aspect, a broadcast information processing apparatus applied to a first device is provided, where the apparatus includes:
an acquisition module, configured to acquire broadcast information; where
the broadcast information is used to indicate at least one of the following:
access control information;
frequency domain location indication information of a synchronization raster or channel raster;
inventory or paging monitoring indication information;
frequency domain related information of ambient Internet of Things communication; and
rate matching indication information; where
the access control information includes at least one of the following:
cell access indication information, the cell access indication information being used to indicate whether access to a cell is allowed;
an indication of whether to acquire cell access indication information;
an indication of traffic types allowed in an access-permitted cell, the traffic types including device-originated traffic and/or device-terminated traffic;
an indication of device power classes allowed in an access-permitted cell; and
an indication of device types allowed in an access-permitted cell, the device types including at least one device type determined based on an energy storage capacity of an Internet of Things device and a capability of the IoT device to generate radio frequency signals for transmission; and
the frequency domain related information of the ambient Internet of Things communication includes at least one of the following:
an ambient Internet of Things communication bandwidth;
a frequency domain interval between ambient Internet of Things communication and non-ambient Internet of Things communication;
relative frequency domain starting location information of the ambient Internet of Things communication bandwidth; and
frequency hopping indication information of ambient Internet of Things communication.

In a fourth aspect, a broadcast information processing apparatus applied to a second device is provided, where the apparatus includes:
a sending module, configured to send broadcast information; where
the broadcast information is used to indicate at least one of the following:
access control information;
frequency domain location indication information of a synchronization raster or channel raster;
inventory or paging monitoring indication information;
frequency domain related information of ambient Internet of Things communication; and
rate matching indication information; where
the access control information includes at least one of the following:
cell access indication information, the cell access indication information being used to indicate whether access to a cell is allowed;
an indication of whether to acquire cell access indication information;
an indication of traffic types allowed in an access-permitted cell, the traffic types including device-originated traffic and/or device-terminated traffic;
an indication of device power classes allowed in an access-permitted cell; and
an indication of device types allowed in an access-permitted cell, the device types including at least one device type determined based on an energy storage capacity of an Internet of Things device and a capability of the IoT device to generate radio frequency signals for transmission; and
the frequency domain related information of the ambient Internet of Things communication includes at least one of the following:
an ambient Internet of Things communication bandwidth;
a frequency domain interval between ambient Internet of Things communication and non-ambient Internet of Things communication;
relative frequency domain starting location information of the ambient Internet of Things communication bandwidth; and
frequency hopping indication information of ambient Internet of Things communication.

In a fifth aspect, a communication device is provided, the communication device including a processor and a memory, where the memory stores a program or an instruction capable of running on the processor, and when the program or instruction is executed by the processor, the steps of the method according to the first aspect or the second aspect are implemented.

In a sixth aspect, a communication device is provided, including a processor and a communication interface.

When the communication device is a first device, the communication interface is configured to acquire broadcast information; where
the broadcast information is used to indicate at least one of the following:
access control information;
frequency domain location indication information of a synchronization raster or channel raster;
inventory or paging monitoring indication information;
frequency domain related information of ambient Internet of Things communication; and
rate matching indication information; where
the access control information includes at least one of the following:
cell access indication information, the cell access indication information being used to indicate whether access to a cell is allowed;
an indication of whether to acquire cell access indication information;
an indication of traffic types allowed in an access-permitted cell, the traffic types including device-originated traffic and/or device-terminated traffic;
an indication of device power classes allowed in an access-permitted cell; and
an indication of device types allowed in an access-permitted cell, the device types including at least one device type determined based on an energy storage capacity of an Internet of Things device and a capability of the IoT device to generate radio frequency signals for transmission; and
the frequency domain related information of the ambient Internet of Things communication includes at least one of the following:
an ambient Internet of Things communication bandwidth;
a frequency domain interval between ambient Internet of Things communication and non-ambient Internet of Things communication;
relative frequency domain starting location information of the ambient Internet of Things communication bandwidth; and
frequency hopping indication information of ambient Internet of Things communication.

When the communication device is a second device, the communication interface is configured to send broadcast information; where
the broadcast information is used to indicate at least one of the following:
access control information;
frequency domain location indication information of a synchronization raster or channel raster;
inventory or paging monitoring indication information;
frequency domain related information of ambient Internet of Things communication; and
rate matching indication information; where
the access control information includes at least one of the following:
cell access indication information, the cell access indication information being used to indicate whether access to a cell is allowed;
an indication of whether to acquire cell access indication information;
an indication of traffic types allowed in an access-permitted cell, the traffic types including device-originated traffic and/or device-terminated traffic;
an indication of device power classes allowed in an access-permitted cell; and
an indication of device types allowed in an access-permitted cell, the device types including at least one device type determined based on an energy storage capacity of an Internet of Things device and a capability of the IoT device to generate radio frequency signals for transmission; and
the frequency domain related information of the ambient Internet of Things communication includes at least one of the following:
an ambient Internet of Things communication bandwidth;
a frequency domain interval between ambient Internet of Things communication and non-ambient Internet of Things communication;
relative frequency domain starting location information of the ambient Internet of Things communication bandwidth; and
frequency hopping indication information of ambient Internet of Things communication.

In a seventh aspect, a readable storage medium is provided, where a program or an instruction is stored on the readable storage medium, and when the program or instruction is executed by a processor, the steps of the method according to the first aspect are implemented, or the steps of the method according to the second aspect are implemented.

In an eighth aspect, a broadcast information processing system is provided, including a first device and a second device, where the first device can be configured to execute the steps of the method according to the first aspect, and the second device can be configured to execute the steps of the method according to the second aspect.

In a ninth aspect, a chip is provided, where the chip includes a processor and a communication interface, the communication interface is coupled to the processor, and the processor is configured to run a program or instruction to implement the method according to the first aspect or to implement the method according to the second aspect.

In a tenth aspect, a computer program/program product is provided, where the computer program/program product is stored in a storage medium, and the program/program product is executed by at least one processor to implement the method according to the first aspect or to implement the method according to the second aspect.

In an eleventh aspect, an embodiment of the present application provides a broadcast information processing apparatus, the apparatus being configured to execute the steps of the broadcast information processing method according to the first aspect or the second aspect.

In the embodiments of the present application, a first device can acquire broadcast information, the broadcast information being used to indicate at least one of the following: access control information, frequency domain location indication information of a synchronization raster or channel raster, inventory or paging monitoring indication information, frequency domain related information of ambient Internet of Things communication, and rate matching indication information; where
the access control information includes at least one of the following:
cell access indication information, the cell access indication information being used to indicate whether access to a cell is allowed;
an indication of whether to acquire cell access indication information;
an indication of traffic types allowed in an access-permitted cell, the traffic types including device-originated traffic and/or device-terminated traffic;
an indication of device power classes allowed in an access-permitted cell;
and
an indication of device types allowed in an access-permitted cell, the device types including at least one device type determined based on an energy storage capacity of an Internet of Things device and a capability of the IoT device to generate radio frequency signals for transmission; and
the frequency domain related information of the ambient Internet of Things communication includes at least one of the following:
an ambient Internet of Things communication bandwidth;
a frequency domain interval between ambient Internet of Things communication and non-ambient Internet of Things communication;
relative frequency domain starting location information of the ambient Internet of Things communication bandwidth; and
frequency hopping indication information of ambient Internet of Things communication.

### BRIEF DESCRIPTION OF DRAWINGS

FIG. 1 is a block diagram of a wireless communication system to which embodiments of the present application can be applied;

FIG. 2 is a flowchart of a broadcast information processing method according to an embodiment of the present application;

FIG. 3 is one of schematic diagrams of offsets of inventory or paging monitoring indication information according to an embodiment of the present application;

FIG. 4 is a second schematic diagram of offsets of inventory or paging monitoring indication information according to an embodiment of the present application;

FIG. 5 is a flowchart of another broadcast information processing method according to an embodiment of the present application;

FIG. 6 is a structural block diagram of a broadcast information processing apparatus according to an embodiment of the present application;

FIG. 7 is a structural block diagram of another broadcast information processing apparatus according to an embodiment of the present application;

FIG. 8 is a structural block diagram of a communication device according to an embodiment of the present application;

FIG. 9 is a structural block diagram of a terminal according to an embodiment of the present application; and

FIG. 10 is a structural block diagram of a network-side device according to an embodiment of the present application.

### DESCRIPTION OF EMBODIMENTS

The following clearly describes the technical solutions in the embodiments of the present application with reference to the accompanying drawings in the embodiments of the present application. Apparently, the described embodiments are only some rather than all of the embodiments of the present application. All other embodiments obtained by persons of ordinary skill in the art based on the embodiments of the present application shall fall within the protection scope of the present application.

Terms such as “first” and “second” in the present application are used to distinguish similar objects and are not used to describe a specific order or sequence. It should be understood that terms used in this way can be interchanged where appropriate, so that the embodiments of the present application can be implemented in an order other than those illustrated or described herein, and objects distinguished by “first” and “second” are generally of one type and do not limit the number of objects, for example, there can be one or more first objects. In addition, “or” in the present application indicates at least one of the connected objects. For example, “A or B” covers three schemes: scheme one: including A but not B; scheme two: including B but not A; scheme three: including both A and B. The character “/” generally indicates an “or” relationship between the associated objects before and after.

The term “indication” in the present application can be a direct indication (or explicit indication) or an indirect indication (or implicit indication). The direct indication can be understood as the sender explicitly informing the receiver of specific information, operations to be performed, or request results in the sent indication; the indirect indication can be understood as the receiver determining corresponding information according to the indication sent by the sender, or performing judgment and determining operations to be performed or request results according to the judgment result.

It is worth noting that the technology described in the embodiments of the present application is not limited to long term evolution (Long Term Evolution, LTE)/LTE-Advanced (LTE-Advanced, LTE-A) systems, but may also be used in other wireless communication systems such as code division multiple access (Code Division Multiple Access, CDMA), time division multiple access (Time Division Multiple Access, TDMA), frequency division multiple access (Frequency Division Multiple Access, FDMA), orthogonal frequency division multiple access (Orthogonal Frequency Division Multiple Access, OFDMA), single-carrier frequency division multiple access (Single-carrier Frequency Division Multiple Access, SC-FDMA), or other systems. The terms “system” and “network” in the embodiments of the present application are often used interchangeably, and the technology described herein may be used in the systems and radio technologies as well as other systems and radio technologies. In the following descriptions, a new radio (New Radio, NR) system is described for an illustration purpose, and NR terms are used in most of the following description, but these technologies can also be applied to systems other than NR systems, such as the 6th Generation (6^{th} Generation, 6G) communication system.

FIG. 1 is a block diagram of a wireless communication system to which embodiments of the present application can be applied. The wireless communication system includes a terminal 11 and a network-side device 12. The terminal 11 can be a mobile phone, a tablet personal computer (Tablet Personal Computer), a laptop computer (Laptop Computer), a notebook computer, a personal digital assistant (Personal Digital Assistant, PDA), a palmtop computer, a netbook, an ultra-mobile personal computer (Ultra-mobile Personal Computer, UMPC), a mobile Internet device (Mobile Internet Device, MID), an augmented reality (Augmented Reality, AR), virtual reality (Virtual Reality, VR) device, a robot, a wearable device (Wearable Device), a flight vehicle (flight vehicle), vehicle user equipment (Vehicle User Equipment, VUE), a ship-borne device, a pedestrian user equipment (Pedestrian User Equipment, PUE), a smart home (home device with wireless communication function, such as a refrigerator, a television, a washing machine, or furniture), a game console, a personal computer (Personal Computer, PC), a teller machine, a self-service machine, or other terminal-side devices. The wearable device includes a smart watch, a smart band, smart earphones, smart glasses, smart jewelry (a smart bracelet, a smart chain bracelet, a smart ring, a smart necklace, a smart anklet, a smart chain anklet, or the like), a smart wrist band, smart clothing, or the like. The vehicle user equipment can also be called vehicle terminal, vehicle controller, vehicle module, vehicle component, vehicle chip, vehicle unit, or the like. It should be noted that the specific type of the terminal 11 is not limited in the embodiments of the present application.

The network-side device 12 may include an access network device or a core network device, where the access network device may also be called a radio access network (Radio Access Network, RAN) device, a radio access network function, or a radio access network unit. The access network device may include a base station, a wireless local area network (Wireless Local Area Network, WLAN) access point (Access Point, AP), a wireless fidelity (Wireless Fidelity, Wi-Fi) node, or the like. The base station may be called Node B (Node B, NB), evolved Node B (Evolved Node B, eNB), next generation Node B (the next generation Node B, gNB), new radio Node B (New Radio Node B, NR Node B), access point, relay base station (Relay Base Station, RBS), serving base station (Serving Base Station, SBS), base transceiver station (Base Transceiver Station, BTS), radio base station, radio transceiver, basic service set (Basic Service Set, BSS), extended service set (Extended Service Set, ESS), home Node B (home Node B, HNB), home evolved Node B (home evolved Node B), transmission reception point (Transmission Reception Point, TRP), or some other suitable term in the field. As long as the same technical effect is achieved, the base station is not limited to specific technical vocabulary. It should be noted that in the embodiments of the present application, only the base station in the NR system is taken as an example for introduction, and the specific type of the base station is not limited.

To facilitate understanding of the broadcast information processing method of the embodiments of the present application, the following related technologies are introduced.

### I. Classification and Characteristics of Ambient IoT (Ambient IoT, A-IoT) Devices

Currently, an ambient Internet of Things device can be characterized according to an energy storage capacity of the ambient Internet of Things device and a capability of the ambient Internet of Things device to generate radio frequency signals for transmission.

A-IoT devices have one of the following energy storage capabilities:
storage capacity 1: having no capability to store energy;
storage capacity 2: being capable of storing energy up to E1 or E2 joules, where E1 may be equal to E2; and
storage capacity 3: being capable of storing energy up to E2 joules.

In addition, based on energy storage capacities of ambient Internet of Things devices and capabilities of the ambient Internet of Things devices to generate radio frequency signals for transmission, Internet of Things devices can be classified into the following three types, namely device A, device B, and device C:
Device A: having no energy storage and no independent signal generation/amplification capability, and performing backscatter transmission;
Device B: having energy storage but no independent signal generation capability, and performing backscatter transmission, where use of the stored energy may include amplification of reflected signals; and
Device C: having energy storage and having an independent signal generation capability, that is, including an active radio frequency component for transmission.

### II. A-IoT Data or Traffic Types, Including the Following Two Types:

(1) device-originated (Device-originated, DO) traffic; and
(2) device-terminated (Device-terminated, DT) traffic.

The device-originated traffic includes device-originated autonomous (DO autonomous, DO-A) traffic and device-terminated triggered (DO device-terminated triggered, DO-DTT) traffic.

DO data indicates that the data flow originates from an A-IoT device; and DT data indicates that the data flow is transmitted to an A-IoT device.

Data flows originating from an A-IoT device (that is, DO data) can be further classified into the following two categories:
DO-A, in which an AIoT device autonomously initiates data transmission, for example, by being connected with a large number of various sensors that collect and actively report information about the environment, devices, and biological entities when necessary; and
DO-DTT, in which a read-write device such as a base station triggers an AIoT device to initiate data transmission, for example, asset identification, status reporting, and tracking, all of which are downlink (DL) triggered reporting, where a reader (Reader) triggers an inventory procedure to collect data from a tag. Since the data is generated or initiated at an Internet of Things (IoT) device, this service should be regarded as a DO service initiated by a tag in response to a control command triggered by a Reader side.
   III. A-IoT System Deployment Scenarios, which can be Classified into the Following Three Scenarios:
scenario 1: A-IoT deployed within an NR system bandwidth, also known as in-band deployment (In-band deployment). In this scenario, in one implementation, a same base station provides services for A-IoT devices and New Radio (New Radio, NR) UEs; in another implementation, different base stations provide services for A-IoT devices and NR UEs;
scenario 2: A-IoT deployed in a guard interval of an NR system, also known as guard band deployment (guard band deployment). In this scenario, in one implementation, a same base station provides services for A-IoT devices and NR UEs. In another implementation, different base stations provide services for A-IoT devices and NR UEs; and
scenario 3: A-IoT deployed outside a guard interval of an NR system (and thus not within an NR system bandwidth), also known as stand-alone deployment (stand-alone deployment). In this scenario, a base station typically provides services only for A-IoT devices.

In related art, the necessary broadcast information currently required for an ambient Internet of Things device to connect with a read-write device has not yet been clearly defined, thereby causing the ambient Internet of Things device to be unable to perform initial connection establishment.

Embodiments of the present application provide a broadcast information processing method, a broadcast information processing apparatus, a communication device, and a storage medium, so as to address the problem in the related art that necessary broadcast information required for an ambient Internet of Things device to access a read-write device is not provided, thereby causing the Internet of Things device to be unable to perform initial connection establishment.

The following describes in detail the broadcast information processing method provided in the embodiments of the present application through some embodiments and their application scenarios with reference to the accompanying drawings.

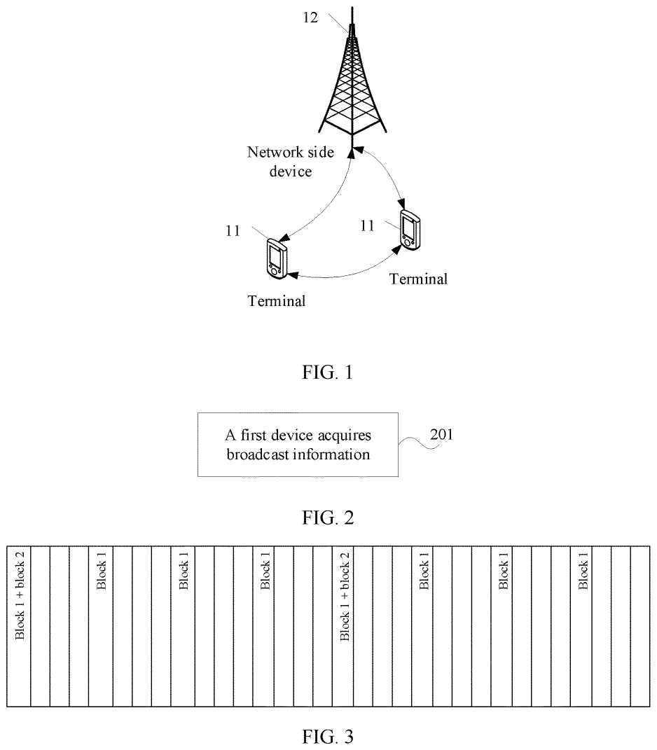

In a first aspect, an embodiment of the present application provides a broadcast information processing method. As shown in FIG. 2, the method may include the following step 201:
step 201: a first device acquires broadcast information, where
the first device may be a terminal device, such as an Internet of Things device.

In addition, with the development of Internet of Things technology, ambient Internet of Things (Ambient IoT, A-IoT) technology has emerged. ambient IoT is centered on a specific target and integrates various possible technical approaches to complete the collection, transmission, and application of environmental and related information in a fast and accurate manner. Therefore, optionally, the above first device may be an ambient Internet of Things device.

In addition, the broadcast information is used to indicate (for example, carry) at least one of the following A-1 to A-5.
Item A-1: access control information, the access control information being used to indicate at least one of whether access to a cell is allowed, whether it is necessary to further acquisition of cell access information, and access conditions allowed by the access-permitted cell.
Item A-2: frequency domain location indication information of a synchronization raster or channel raster; the frequency domain location information of the synchronization raster or channel raster being used to indicate the frequency domain location of the broadcast information.
Item A-3: inventory or paging monitoring indication information, the inventory or paging monitoring indication information being used to indicate at least one of whether to monitor control information in ambient Internet of Things communication (including at least one of a paging command, an inventory command, and a selection command), and whether it is necessary to further acquisition of inventory or paging grouping indication information;
Item A-4: frequency domain related information of ambient Internet of Things communication.

In an embodiment, the above broadcast information may be broadcast information of ambient Internet of Things communication, that is, at least one of the above items A-1 to A-4 may be included (that is, carried) in the broadcast information of ambient Internet of Things communication.
Item A-5: rate matching indication information.

In an embodiment, the rate matching indication information is used to indicate information about resources unavailable for ambient Internet of Things communication, or it can be understood that the rate matching indication information is used to indicate information of resource mapping not used for ambient Internet of Things communication.

Optionally, frequency domain related information of non-ambient Internet of Things communication may also be indicated in the broadcast information of ambient Internet of Things communication, so that a device performing ambient Internet of Things communication can learn which resources are unavailable based on information about resources occupied by a non-ambient Internet of Things.

Similarly, optionally, in the case that the broadcast information in the above step 201 is broadcast information of ambient Internet of Things communication, the frequency domain related information of ambient Internet of Things communication is also carried in broadcast information of non-ambient Internet of Things communication, so that non-ambient Internet of Things communication can learn which resources are unavailable based on the information about resources occupied by an ambient Internet of Things.

In one embodiment, at least one item of information in the frequency domain related information of ambient Internet of Things communication is carried in at least one of the following:
broadcast information of ambient Internet of Things communication; and
broadcast information of non-ambient Internet of Things communication.

By way of example, partial information in the frequency domain related information of ambient Internet of Things communication is carried in the broadcast information of ambient Internet of Things communication, and the remaining information is carried in the broadcast information of non-ambient Internet of Things communication; or, all information in the frequency domain related information of ambient Internet of Things communication is carried in the broadcast information of ambient Internet of Things communication; or, all information in the frequency domain related information of ambient Internet of Things communication is carried in the broadcast information of non-ambient Internet of Things communication.

It can be seen from the above step 201 that in the embodiments of the present application, a first device can acquire broadcast information, the broadcast information being used to indicate at least one of the following: access control information, frequency domain location indication information of a synchronization raster or channel raster, inventory or paging monitoring indication information, frequency domain related information of ambient Internet of Things communication, and rate matching indication information. It can be seen that in the embodiments of the present application, at least one item of information above may be indicated in the broadcast information, so that the first device can acquire the at least one item of information above through the broadcast information to facilitate initial access. Accordingly, in the embodiments of the present application, necessary broadcast information required for Internet of Things devices to perform initial access is provided, addressing the problem in the related art that necessary broadcast information required for an ambient Internet of Things device to access a read-write device is not provided, thereby causing the Internet of Thing devices to be unable to perform initial connection establishment.

Optionally, the broadcast information includes at least one of a master information block (that is, master information block Master Information Block, MIB) and physical layer indication information; and it can be understood that the physical layer indication information is added when the MIB is processed at the physical layer.

It can be understood that at least one item of information in the above A-1 to A-4 may be carried in at least one of the master information block and the physical layer indication information.

Optionally, the broadcast information is carried in at least one of a low-power synchronization signal and a physical broadcast channel (in ambient Internet of Things communication).

It can be understood that at least one item of information in the above A-1 to A-4 may be carried in at least one of a low-power synchronization signal and a physical broadcast channel.

Optionally, the access control information includes at least one of the following items B-1 to B-5.
Item B-1: cell access indication information, the cell access indication information being used to indicate whether access to a cell is allowed.

It can be understood that the cell access indication information may correspond to a cell, that is, one piece of cell access indication information is present for one cell, and the cell access indication information is used to indicate whether access to the cell sending the broadcast information is allowed.
Item B-2: an indication of whether to acquire cell access indication information.

In the case described in item B-2, the access control information may not include the cell access indication information. By way of example, if the access control information is carried in a MIB, then the cell access indication information may not be carried in the MIB, but carried in other system information; however, the MIB carries an indication of whether to acquire the cell access indication information, so that whether to acquire the cell access indication information can be determined based on the indication carried in the MIB; and if yes, the cell access indication information can be acquired in other system information, and then it is determined based on the acquired cell access indication information that whether access to the cell to which the cell access indication information pertains is allowed.

Optionally, the cell access indication information includes specific cell access conditions, device types required for cell access, device capabilities, and the like.
Item B-3: an indication of traffic types allowed in an access-permitted cell, the traffic types including device-originated traffic and/or device-terminated traffic.

In an embodiment, the indication of traffic types allowed in an access-permitted cell is used to indicate traffic types allowed by the cell, which means that devices supporting the traffic types allowed by the cell can access the cell, that is, if a traffic type supported by a device is included in the traffic types allowed by the cell, the device can access the cell.

Or, in another embodiment: the indication of traffic types allowed in an access-permitted cell is used to indicate whether devices supporting a predetermined traffic type are allowed to access the cell, where the predetermined traffic type may include device-originated traffic and device-terminated traffic.

It can be understood that the indication of traffic types allowed in an access-permitted cell may correspond to a cell, that is, one indication of traffic types allowed in an access-permitted cell is present for one cell, and the indication of traffic types allowed in an access-permitted cell is used to indicate the traffic types allowed by the cell to which the indication pertains. For example, the indication of traffic types allowed in an access-permitted cell for a certain cell indicates that the cell allows device-terminated traffic, then devices supporting device-terminated traffic can access the cell.

Optionally, the device-originated traffic includes at least one of: device-originated autonomous traffic and device-originated device-terminated triggered traffic.
Item B-4: an indication of device power classes allowed in an access-permitted cell;
In an embodiment, the indication of device power classes allowed in an access-permitted cell is used to indicate device power classes allowed by the cell, that is, devices using the device power classes allowed by the cell can access the cell.

In another embodiment, the indication of device power classes allowed in an access-permitted cell is used to indicate whether devices supporting a predetermined device power class are allowed to access the cell.

For example, the power classes may include at least one of 0 dBm power class (dBm power class) and −10 dBm power class.

It can be understood that the indication of device power classes allowed in an access-permitted cell may correspond to a cell, that is, one indication of device power classes allowed in an access-permitted cell is present for one cell, and the indication of device power classes allowed in an access-permitted cell is used to indicate the device power classes allowed by the cell to which the indication pertains. For example, the indication of device power classes allowed in an access-permitted cell for a certain cell indicates that the cell allows 0 dBm power class, then devices using 0 dBm power class can access the cell.

It can be seen from the above items B-1 to B-4 that, in one embodiment, access devices can be managed from aspects of access control, traffic types, and device power by combining traffic types or device power classes of the access-permitted cell. For example, steps for a terminal to determine whether access to a cell is allowed are:
(1) first determining that the access-permitted cell indication information is true;
(2) then determining whether the terminal satisfies the traffic type or device power class of the access-permitted cell.

The terminal is allowed to access the cell only when both (1) and (2) are satisfied. Otherwise, if (1) is not satisfied, the cell is directly determined to be an access-barred cell. It can be understood that if a terminal searches for multiple cells and satisfies the conditions (1) and (2) for multiple cells, in such a case, a specific cell to be accessed among the cells satisfying the conditions may be determined by using an existing cell selection method.
Item B-5: an indication of device types allowed in an access-permitted cell, the device types including at least one device type determined based on an energy storage capacity of an Internet of Things device and a capability of the IoT device to generate radio frequency signals for transmission. For example, the device types include at least one of above device A, device B, and device C.

In an embodiment, the indication of device types allowed in an access-permitted cell is used to indicate device types allowed by the cell, that is, devices belonging to the device types allowed by the cell can access the cell.

Alternatively, in another embodiment, the indication of device types allowed in an access-permitted cell is used to indicate whether devices supporting a predetermined device type are allowed to access the cell.

It can be understood that the indication of device types allowed in an access-permitted cell may correspond to a cell, that is, one indication of device types allowed in an access-permitted cell is present for one cell, then the indication of device types allowed in an access-permitted cell is used to indicate the device types allowed by the cell to which the indication pertains. For example, the indication of device types allowed in an access-permitted cell for a certain cell indicates that the cell allows access by devices A, then devices A can access the cell.

It should be noted that the above device types may also be referred to as device power consumption types.

It can be seen from the above description that, in an embodiment, the above access control information may correspond to a cell, that is, one piece of access control information is present for one cell, so that each cell can broadcast its own access control information through broadcast information.

Optionally, the frequency domain location indication information of a synchronization raster or channel raster satisfies at least one of the following items C-1 to C-2.
Item C-1: the frequency domain location indication information of the synchronization raster or channel raster includes index information of a synchronization raster or index information of a channel raster.

Optionally, at least part of the index information of the synchronization raster or at least part of the index information of the channel raster in the frequency domain location indication information of the synchronization raster or channel raster may be included in the MIB, and the remaining parts is carried in the physical layer indication information.

For example, the broadcast information only includes an indication of X least significant bits (Least Significant Bit, LSB) in the index. Optionally, additional Y most significant bits (Most Significant Bit, MSB) are indicated in system information other than the broadcast information, for example, Y bits are indicated in system information block 1 (System Information Block 1, SIB1). That is, complete index information is carried by X+Y bits.

Alternatively, for example, the MIB only includes an indication of the LSB of X bits in the index, and additional MSB of Y bits are indicated in the above physical layer indication information.

Optionally, the step size of a synchronization raster or channel raster is 100 kilohertz (kHz) or 200 kHz. It can be understood that the index of the synchronization raster or channel raster may be agreed upon by a protocol.

In addition, since in some cases, directly indicating the position or number of a raster (raster) may result in excessively large values. To enable more efficient indication, in one case, rasters may be numbered within the bandwidth (band) in which ambient Internet of Things communication operates; in another case, a relative raster identification (raster ID) may be indicated based on the maximum possible frequency offset of the ambient Internet of Things device. For example, assuming that the maximum frequency offset of an ambient Internet of Things device is 180 kHz, and that the synchronization raster (sync raster) is configured with a step size of 100 kHz, the 180 KHz frequency offset would only span 2 sync rasters, so that the ambient Internet of Things device would be unable to identify which of the two sync rasters the currently received broadcast information corresponds to. In this case, a 1-bit raster ID (0 or 1) may be used to indicate the target raster, thereby achieving the purpose of correcting the frequency offset.
Item C-2: the frequency domain location indication information of a synchronization raster or channel raster is associated with a deployment mode of ambient Internet of Things, that is, part or all of the frequency domain location indication information of the synchronization raster or channel raster is related to the deployment mode of ambient Internet of Things.

Optionally, the association relationship between the frequency domain location indication information of the synchronization raster or channel raster and the deployment mode of ambient Internet of Things satisfies at least one of the following: frequency domain location indication information of a synchronization raster or channel raster exists in in-band deployment mode;
frequency domain location indication information of a synchronization raster or channel raster exists in guard band deployment mode; and
frequency domain location indication information of a synchronization raster or channel raster does not exist in stand-alone deployment mode.

Accordingly, in one embodiment, frequency domain location indication information of a synchronization raster or channel raster may be configured in the in-band deployment mode and the guard band deployment mode, whereas frequency domain location indication information of a synchronization raster or channel raster may not be configured in stand-alone deployment mode. The frequency domain location indication information of a synchronization raster or channel raster associated with each of the in-band deployment mode and the guard band deployment mode may be the same or different. It should be noted that “different” here means that the value range of the frequency domain location may be different.

It should be noted that in the above stand-alone deployment mode, frequency domain related information of ambient Internet of Things communication may be associated. In stand-alone deployment mode, relative position information of the frequency domain location in which the broadcast information is received with respect to an initial access bandwidth part (bandwidth Part, BWP) is configured; where the initial access BWP may be understood as a bandwidth for receiving other than other system information, for example, a bandwidth for receiving SIBx messages.

Optionally, the inventory or paging monitoring indication information satisfies at least one of the following items D-1 to D-3:
item D-1: a transmission period of the inventory or paging monitoring indication information is an integer multiple of a transmission period of the broadcast information;
item D-2: the inventory or paging monitoring indication information is transmitted at a specific transmission occasion of the broadcast information; that is, the inventory or paging monitoring indication information is not transmitted at occasions other than the specific transmission occasion of the broadcast information; and
item D-3: the inventory or paging monitoring indication information and other information are transmitted in different information blocks, that is, the inventory or paging monitoring indication information and other information occupy different time domain resources; where the other information includes at least one item of information indicated by the broadcast information except the inventory or paging monitoring indication information.

By way of example, in an embodiment, the other information and the inventory or paging monitoring indication information are transmitted in different blocks. For example, the other information is transmitted on block 1, and the inventory or paging monitoring indication information is transmitted on block 2. Optionally, the transmission period of block 2 is different from the transmission period of block 1; for example, the period of block 2 is equal to a paging or inventory period (for example, 1280 ms), and block 2 is transmitted at a specific transmission occasion of the broadcast information. As shown in FIG. 3, it can be seen that the period of block 2 is four times the period of block 1; for example, the period of block 1 is 320 ms, then the period of block 2 is 4*320 ms=1280 ms.

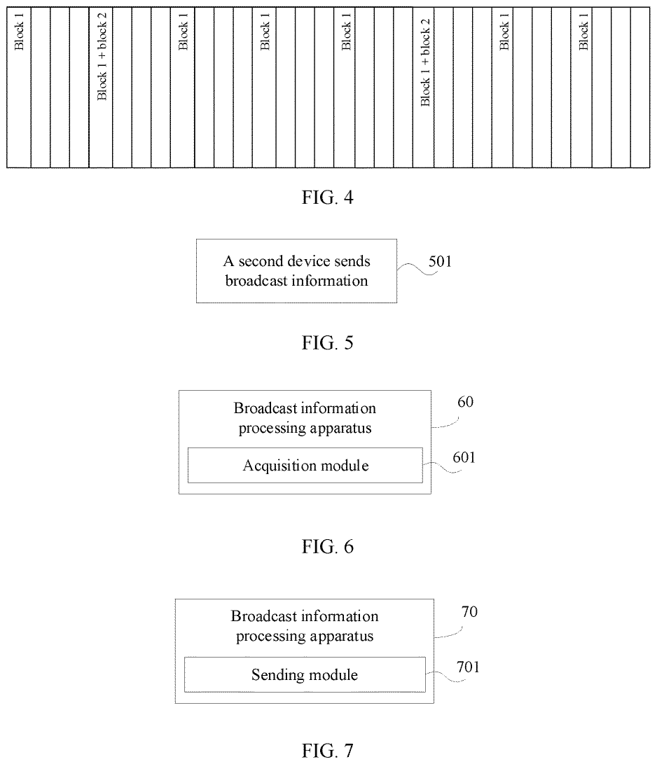

Optionally, the offset of the inventory or paging monitoring indication information or block 2 may be one of 0, 1, 2, 3; and the offset is relative to block 1, where an offset of 0 means that block 1 and block 2 are included in the transmission occasion of the first broadcast information starting from system frame number (System Frame Number, SFN) 0, as shown in FIG. 3; an offset of 1 means that block 1 and block 2 are included in the transmission occasion of the second broadcast information starting from SFN 0, as shown in FIG. 4; similarly, an offset of 2 means that block 1 and block 2 are included in the transmission occasion of the third broadcast information starting from SFN 0; an offset of 3 means that block 1 and block 2 are included in the transmission occasion of the fourth broadcast information starting from SFN 0.

It should be noted that, for illustrative purposes, in FIG. 3 to FIG. 4, starting from SFN 0, each cell includes 8 system frames, that is, each cell occupies 80 ms.

Optionally, the frequency domain related information of the ambient Internet of Things communication includes at least one of the following items E-1 to E-4:
item E-1: an ambient Internet of Things communication bandwidth;
item E-2: a frequency domain interval between ambient Internet of Things communication and non-ambient Internet of Things communication;
item E-3: relative frequency domain starting location information of the ambient Internet of Things communication bandwidth, where the relative frequency domain starting location information may be relative to non-ambient Internet of Things communication, for example, frequency domain location information of ambient Internet of Things communication bandwidth relative to NR communication bandwidth; and
item E-4: frequency hopping indication information of ambient Internet of Things communication. For example, the A-IoT communication may be configured to support frequency hopping at a certain time granularity. Optionally, the frequency domain granularity of frequency hopping may be on a resource block (Resource Block, RB) level, a carrier level, or a subcarrier level.

Optionally, the rate matching indication information includes pattern (pattern) information of unavailable resources, where the pattern information of unavailable resources includes at least one of the following items V-1 to V-5:
item V-1: information about unavailable symbols;
item V-2: information about unavailable subframes;
item V-3: information about unavailable system frames;
item V-4: unavailable frequency domain information; and
item V-5: period information of the unavailable resource pattern.

It should be noted that time domain resources occupied by the unavailable resource pattern are not used for ambient Internet of Things communication.

The reader, that is, the second device (for example, a network-side device), skips the above unavailable resources during resource mapping.

Optionally, the broadcast information is transmitted in at least one information block; where
the at least one information block satisfies at least one of the following items F-1 to F-7:
item F-1: the at least one information block is separately added with a cyclic redundancy check (Cyclic redundancy check, CRC);
item F-2: the at least one information block is separately subjected to channel coding;
item F-3: the at least one information block is separately subjected to scrambling;
item F-4: the at least one information block is self-decodable;
item F-5: multiple information blocks occupy different time domain resources;
item F-6: multiple information blocks occupy different frequency domain resources; and
item F-7: transmission periodicities of multiple information blocks are the same or different.

Accordingly, in one embodiment, different transmission blocks for transmitting broadcast information may be processed in at least one of the following manners: being separately added with a CRC, being separately subjected to channel coding, being separately subjected to scrambling, or being self-decodable. In addition, at least one of time domain resources and frequency domain resources occupied by different transmission blocks may be different; and transmission periodicities of different transmission blocks may also be different.

For example, the inventory or paging monitoring indication information and the other information (including other information in the broadcast information except the inventory or paging monitoring indication information) are transmitted in different blocks, for example, transmitted on block 1 and block 2 respectively, where block 1 and block 2 can satisfy at least one of the above items F-1 to F-7.

Optionally, the method further includes at least one of the following steps J-1 to J-4.
Step J-1: In a case that the broadcast information indicates the access control information, the first device determines, based on the access control information, whether access to a cell is allowed, or determines whether to acquire cell access indication information.

It can be understood that, in a case that the access control information included in the broadcast information includes cell access indication information, the first device determines, based on the cell access indication information, whether access to a cell is allowed; in a case that the access control information included in the broadcast information includes an indication of whether to acquire cell access indication information, the first device determines, based on the indication of whether to acquire cell access indication information, whether to acquire cell access indication information.
Step J-2: In a case that the broadcast information indicates frequency domain location indication information of a synchronization raster or channel raster, the first device determines, based on the frequency domain location indication information of a synchronization raster or channel raster, a frequency domain location of the broadcast information (for example, a frequency domain location carrying a broadcast channel).
Step J-3: In a case that the broadcast information indicates the rate matching indication information, the first device performs data reception and demodulation based on the rate matching indication information.

In an embodiment, the rate matching indication information is used to indicate information about resources unavailable for ambient Internet of Things communication, then the first device can perform data reception and demodulation in resources other than the resources indicated by the rate matching indication information.
Step J-4: In a case that the broadcast information indicates the inventory or paging monitoring indication information, the first device determines, based on the inventory or paging monitoring indication information, at least one of the following:
whether to start monitoring control information in ambient Internet of Things communication, where the control information includes at least one of a paging command, an inventory command, and a selection command; and
whether to acquire inventory or paging grouping indication information, the inventory or paging grouping indication information being used to indicate whether first devices in one or more groups start monitoring control information, the groups being groups of Internet of Things devices.

It should be noted that, if the first device is indicated to monitor inventory or paging, the first device starts monitoring for control information. If the first device is indicated not to monitor inventory or paging, the first device skips monitoring for control information. Thereby, flexible power saving for control information monitoring by the terminal can be achieved. For example, the control information is an inventory command, a selection command, a paging command, or the like. The inventory command can be understood as a command indicating that the first device starts inventory.

In one embodiment, the MIB carries inventory or paging monitoring indication information. Due to limited bits, for example, only one bit of indication information is used to indicate whether all first devices monitor control information or not. For finer-grained indication of whether a first device monitors control information, inventory or paging grouping indication information may be carried in system information (SIBX) other than the MIB. That is, an indication of whether to monitor control information is provided for first devices on a per-group basis. In this case, a first device is required to monitor control information in ambient Internet of Things (A-IoT) communication only when it determines that the group to which the first device belongs to with which the first device is associated with is required to monitor control information in the A-IoT communication.

It can be understood that the inventory or paging monitoring indication information can be understood as indication information indicating whether to monitor inventory monitoring grouping indication information.

Optionally, the broadcast information further indicates (for example, carries) at least one of the following items H-1 to H-6:
item H-1: time synchronization information; where
the time synchronization information may include synchronization information for time units of ambient Internet of Things communication, for example, on at least one of system frame level and hyperframe level;
item H-2: cell identification information;
item H-3: scheduling related information of a first system information block SIB1; where
after acquiring the SIB1 scheduling information indicated by the broadcast information, the first device may proceed to a corresponding position to demodulate scheduling information of SIB1 or directly demodulate SIB1 information based on the SIB1 scheduling information.
item H-4: deployment mode information of ambient Internet of Things, the deployment mode including at least one of the above in-band deployment mode, guard band deployment mode, and stand-alone deployment mode;
item H-5: system information SI update indication information;
where after receiving the SI update indication information, if the update indication information indicates that SI information has been updated, the first device proceeds to a corresponding SI reception position to receive updated SI information, and if the update indication information indicates that SI information is not updated, there is no need to detect and demodulate SI information, thereby saving power consumption for monitoring SI information; and
item H-6: Earthquake and Tsunami Warning System ETWS notification information.

The ETWS notification information carries earthquake and tsunami notifications, so it has very high importance and timeliness requirements. In the embodiments of the present application, ETWS notification information may be carried in broadcast information (for example, MIB). Since broadcast information is transmitted more frequently compared to SIBs, carrying ETWS notification information through broadcast information can achieve the effect of reducing delay of earthquake and tsunami notifications.

Optionally, a change or update period of the broadcast information is greater than or equal to a transmission period of a low-power synchronization signal; where the low-power synchronization signal is used for at least one of synchronization and measurement; in addition, the transmission period of the broadcast information may be specified by a protocol.

In a second aspect, an embodiment of the present application further provides a broadcast information processing method. As shown in FIG. 5, the method may include the following step 501:
step 501: a second device sends broadcast information; where
the second device may be a network-side device (for example, a base station).

In addition, the broadcast information is used to indicate (for example, carry) at least one of the following items A-1 to A-5:
item A-1: access control information;
item A-2: frequency domain location indication information of a synchronization raster or channel raster;
item A-3: inventory or paging monitoring indication information;
item A-4: frequency domain related information of ambient Internet of Things communication; and
item A-5: rate matching indication information; where
relevant descriptions of items A-1 to A-4 can refer to the foregoing, and details are not repeated here.

From the above step 501, it can be seen that in the embodiments of the present application, a second device can send broadcast information, the broadcast information being used to indicate at least one of the following: access control information, frequency domain location indication information of a synchronization raster or channel raster, inventory or paging monitoring indication information, frequency domain related information of ambient Internet of Things communication, and rate matching indication information. It can be seen that in the embodiments of the present application, the at least one item of information above may be indicated in the broadcast information, so that a first device can acquire the at least one item of information above through the broadcast information to facilitate initial access. Therefore, in the embodiments of the present application, necessary broadcast information required for an Internet of Things device to perform initial access is provided, addressing the problem in the related art that necessary broadcast information required for ambient Internet of Things devices to access read-write devices is not provided, thereby causing the Internet of Things device to be unable to perform initial connection establishment.

Optionally, the broadcast information includes at least one of a master information block (that is, master information block Master Information Block, MIB) and physical layer indication information. It can be understood that the physical layer indication information is added during processing of the MIB at the physical layer.

It can be understood that at least one item of information in the above A-1 to A-4 may be carried in at least one of the master information block and the physical layer indication information.

Optionally, the broadcast information is carried in at least one of a low-power synchronization signal and a physical broadcast channel (in ambient Internet of Things communication).

It can be understood that at least one item of information in the above A-1 to A-4 may be carried in at least one of the low-power synchronization signal and the physical broadcast channel.

Optionally, the access control information includes at least one of the following items B-1 to B-5:
item B-1: cell access indication information, the cell access indication information being used to indicate whether access to a cell is allowed;
item B-2: an indication of whether to acquire cell access indication information;
item B-3: an indication of traffic types allowed in an access-permitted cell, the traffic types including device-originated traffic and/or device-terminated traffic;
item B-4: an indication of device power classes allowed in an access-permitted cell; and
item B-5: an indication of device types allowed in an access-permitted cell, the device types including at least one device type determined based on an energy storage capacity of an Internet of Things device and a capability of the IoT device to generate radio frequency signals for transmission; where
relevant descriptions of items B-1 to B-5 can refer to the foregoing, and details are not repeated here.

Optionally, the device-originated traffic includes at least one of the following:
device-originated autonomous traffic; and
device-originated device-terminated triggered traffic.

Optionally, the frequency domain location indication information of a synchronization raster or channel raster satisfies at least one of the following items C-1 to C-2:
item C-1: the frequency domain location indication information of the synchronization raster or channel raster includes index information of a synchronization raster or index information of a channel raster; and
item C-2: the frequency domain location indication information of a synchronization raster or channel raster is associated with a deployment mode of ambient Internet of Things; where
relevant descriptions of items C-1 to C-2 can refer to the foregoing, and details are not repeated here.

Optionally, an association relationship between the frequency domain location indication information of the synchronization raster or channel raster and the deployment mode of ambient Internet of Things satisfies at least one of the following:
frequency domain location indication information of a synchronization raster or channel raster exists in in-band deployment mode;
frequency domain location indication information of a synchronization raster or channel raster exists in guard band deployment mode; and
frequency domain location indication information of a synchronization raster or channel raster does not exist in stand-alone deployment mode.

Accordingly, in one embodiment, frequency domain location indication information of a synchronization raster or channel raster may be configured in the in-band deployment mode and the guard band deployment mode, whereas frequency domain location indication information of a synchronization raster or channel raster may not be configured in stand-alone deployment mode. The frequency domain location indication information of a synchronization raster or channel raster associated with each of the in-band deployment mode and the guard band deployment mode may be the same or different. It should be noted that “different” here means that the value range of the frequency domain location may be different.

Optionally, the inventory or paging monitoring indication information satisfies at least one of the following items D-1 to D-3:
item D-1: a transmission period of the inventory or paging monitoring indication information is an integer multiple of a transmission period of the broadcast information;
item D-2: the inventory or paging monitoring indication information is transmitted at a specific transmission occasion of the broadcast information; and
item D-3: the inventory or paging monitoring indication information and other information are transmitted in different information blocks, where the other information includes at least one item of information indicated by the broadcast information except the inventory or paging monitoring indication information; where
relevant descriptions of items D-1 to D-3 can refer to the foregoing, and details are not repeated here.

Optionally, the frequency domain related information of the ambient Internet of Things communication includes at least one of the following items E-1 to E-4:
item E-1: ambient Internet of Things communication bandwidth;
item E-2: frequency domain interval between ambient Internet of Things communication and non-ambient Internet of Things communication;
item E-3: relative frequency domain starting location information of the ambient Internet of Things communication bandwidth, where the relative frequency domain starting location information may be relative to non-ambient Internet of Things communication, for example, frequency domain location information of ambient Internet of Things communication bandwidth relative to NR communication bandwidth; and
item E-4: frequency hopping indication information of ambient Internet of Things communication. For example, the ambient Internet of Things may be configured to support frequency hopping on a certain time granularity within a non-ambient Internet of Things bandwidth.

Optionally, in a case that the broadcast information is broadcast information of ambient Internet of Things communication, at least one item of information in the frequency domain related information of the ambient Internet of Things communication is further carried in broadcast information of non-ambient Internet of Things communication, so that the non-ambient Internet of Things terminal side and the network side can learn which resources are unavailable.

That is, it can be understood that at least one item of information in the frequency domain related information of ambient Internet of Things communication is carried in at least one of the following:
broadcast information of ambient Internet of Things communication; and
broadcast information of non-ambient Internet of Things communication.

Optionally, the rate matching indication information is used to indicate information about resources unavailable for ambient Internet of Things communication.

Optionally, the rate matching indication information includes pattern information of unavailable resources; where
the pattern information of unavailable resources indicates at least one of the following items V-1 to V-5:
item V-1: unavailable symbol information;
item V-2: unavailable subframe information;
item V-3: unavailable system frame information;
item V-4: unavailable frequency domain information; and
item V-5: period information of the unavailable resource pattern.

Relevant descriptions of items V-1 to V-5 can refer to the foregoing, and details are not repeated here. Optionally, the method further includes:
in a case that the broadcast information indicates the rate matching indication information, performing, by the second device, resource mapping of ambient Internet of Things communication based on the rate matching indication information.

The rate matching indication information is used to indicate information about resources unavailable for ambient Internet of Things communication. Accordingly, the second device may skip unavailable resources for resource mapping based on the above pattern information of unavailable resources included in the rate matching indication information.

Optionally, the broadcast information is transmitted in at least one information block; where
the at least one information block satisfies at least one of the following items F-1 to F-7:
item F-1: the at least one information block is separately added with a cyclic redundancy check;
item F-2: the at least one information block is separately subjected to channel coding;
item F-3: the at least one information block is separately subjected to scrambling;
item F-4: the at least one information block is self-decodable;
item F-5: multiple information blocks occupy different time domain resources;
item F-6: multiple information blocks occupy different frequency domain resources; and
item F-7: transmission periodicities of multiple information blocks are the same or different; where
relevant descriptions of items F-1 to F-7 can refer to the foregoing, and details are not repeated here.

Optionally, the broadcast information further indicates (for example, carries) at least one of the following items H-1 to H-6:
item H-1: time synchronization information;
item H-2: cell identification information;
item H-3: scheduling related information of a first system information block SIB1;
item H-4: deployment mode information of ambient Internet of Things;
item H-5: system information SI update indication information; and
item H-6: Earthquake and Tsunami Warning System ETWS notification information; where
relevant descriptions of items H-1 to H-6 can refer to the foregoing, and details are not repeated here.

Optionally, a change or update period of the broadcast information is greater than or equal to a transmission period of a low-power synchronization signal; where the low-power synchronization signal is used for at least one of synchronization and measurement; in addition, the transmission period of the broadcast information may be specified by a protocol.

It can be seen from the above description that specific implementations of the broadcast information processing method of the embodiments of the present application can be as described in the following implementations 1 to 3.

Implementation 1: access control information is carried in broadcast information (for example, MIB).

A base station periodically sends broadcast information, including necessary information for initial access and the like, where a transmission flow of broadcast information in ambient Internet of Things is as described in the following steps J-1 to J-6:
step L-1: after being powered up, an Internet of Things device starts up; where the Internet of Things device is a device in ambient Internet of Things;
step L-2: the Internet of Things device performs cell search and decodes MIB, where the MIB includes access control information used to indicate whether access to a cell is allowed; it should be noted that one cell corresponds to one piece of access control information;
step L-3: the Internet of Things device stores the MIB;
step L-4: the Internet of Things device determines, based on the access control information in the MIB, whether access to the cell to which the access control information pertains is allowed; for example, if the access control information includes an indication of traffic types allowed in an access-permitted cell, after obtaining the MIB, the Internet of Things device determines whether traffic types supported by itself are included in type information given in the indication of traffic types of the access-permitted cell; if yes, step J-5 is performed; or if not, the IoT device terminates access to the cell;
step L-5: if SIB scheduling information is indicated in the MIB, the Internet of Things device demodulates SIB information at a corresponding position based on the SIB scheduling information; and
step L-6: the Internet of Things device stores the demodulated SIB, and accesses the cell to which the above access broadcast information pertains based on the demodulated SIB.

It can be seen from the above steps that, in ambient Internet of Things communication, finer-grained restriction of devices supporting certain traffic types from accessing a cell can be achieved by indicating traffic types allowed in an access-permitted cell via MIB, effectively improving cell access efficiency.

Implementation 2: inventory monitoring indication information is carried in broadcast information (for example, MIB).

In this implementation, inventory monitoring indication information may be carried in broadcast information, where the inventory monitoring can be understood as control channel monitoring, that is, the broadcast information may carry advance indication information on whether a control channel is to be monitored.

By way of example, a network-side device (for example, as a reader) periodically broadcasts broadcast information to an Internet of Things device; if inventory monitoring indication information carried in a certain broadcast information indicates that the Internet of Things device should monitor an inventory control channel, the Internet of Things device starts monitoring the control channel. After a period of time, if inventory monitoring indication information carried in broadcast information indicates that the Internet of Things device need not monitor the control channel, the Internet of Things device stops monitoring the control channel, thereby achieving highly flexible indication.

In addition, broadcast information may be carried in a low power synchronization signal block (Low Power Synchronization Signal Block, LP-SSB), then the Internet of Things device, while receiving broadcast information and completing measurement and synchronization, can also complete reception of the above inventory monitoring indication information, thereby saving monitoring power consumption for inventory monitoring indication information, and further reducing monitoring power consumption of the Internet of Things device.

Optionally, the network side may alternatively group Internet of Things devices (for example, by notifying an Internet of Things device of its subgroup identifier (subgroup ID) through a non-access stratum (Non-Access Stratum, NAS) message), and indicate the inventory monitoring indication information on a per-groups. For example, the network side configures four groups of Internet of Things devices, and uses 4 bits to respectively indicate whether these 4 groups should perform control channel monitoring. In this case, each group of one Internet of Things device corresponds to one piece of inventory monitoring indication information.

Optionally, to avoid ping-pong effect of inventory monitoring behavior (that is, behavior of control channel monitoring), the network side configures, or a protocol further specifies, the duration of each toggle of the inventory monitoring indication information carried in the broadcast information (referring to the switching from monitoring to not monitoring or from not monitoring to monitoring). That is, a minimum duration is defined for either monitoring or not monitoring inventory. During the minimum duration, the Internet of Things device maintains its inventory monitoring state unchanged by default.

Optionally, broadcast information may further carry SI information update indication information and ETWS notification information, where the SI update indication information is used to indicate whether SI information is updated.

After receiving the SI update indication information, if the SI update indication information indicates that SI information has been updated, the Internet of Things device proceeds to a corresponding SI reception position to receive updated SI information, and if the SI update indication information indicates that SI information is not updated, there is no need to detect and demodulate SI information, thereby saving power consumption for monitoring SI information update indication.

In addition, the ETWS notification information carries earthquake and tsunami notifications, so it has very high importance and timeliness requirements. In the embodiments of the present application, ETWS notification information may be carried in broadcast information. Since broadcast information is transmitted more frequently compared to SIBs, carrying ETWS notification information through broadcast information can achieve the effect of reducing delay.

Implementation 3: frequency domain location indication information of a synchronization raster or channel raster is carried in broadcast information (for example, MIB).

In this implementation, frequency domain location indication information of a synchronization raster or channel raster may be carried in broadcast information, where the frequency domain location indication information of the synchronization raster or channel raster may include part or all of information of a synchronization raster or channel raster index; and the synchronization raster index and a corresponding mapping (mapping) table between the synchronization raster index and a corresponding synchronization raster frequency domain location may be specified by a protocol.

The following examples are described with reference to the synchronization raster index.

By way of example, since broadcast information needs to ensure transmission reliability, the number of information bits that can be carried is very limited. Therefore, an indication including X least significant bits (least significant bit, LSB) of the index may be indicated in broadcast information. Optionally, additional broadcast information, for example, Y bits, is indicated in other system information other than the broadcast information, for example, Y bits are indicated in SIB1. That is: complete index information is carried by X+Y bits.

Since an Internet of Things device has low complexity, a frequency offset thereof may be greater than 100 KHz, for example, reaching 200 KHz. Therefore, optionally, the synchronization raster step size may be 200 KHz.

In addition, since each piece of synchronization raster index information corresponds to a determined frequency domain location, the Internet of Things device can obtain a corresponding determined frequency domain location based on the acquired synchronization raster index information, thereby adjusting its own frequency offset (that is, performing frequency offset calibration) based on the determined frequency domain location.

Optionally, the frequency domain location indication information of the synchronization raster or channel raster may be configured in combination with a deployment mode of ambient Internet of Things.

For example, frequency domain location indication information of a synchronization raster or channel raster is configured in the in-band deployment mode and the guard band deployment mode, whereas frequency domain location indication information of a synchronization raster or channel raster is not configured in stand-alone deployment mode. The frequency domain location indication information of a synchronization raster or channel raster associated with each of the in-band deployment mode and the guard band deployment mode may be the same or different. It should be noted that “different” here means that the value range of the frequency domain location may be different.

It can be seen from the above implementation 1 to 3 that the embodiments of the present application provide a design of necessary system information design carried in broadcast information (for example, a master information block) acquired by an Internet of Things device during an initial access process, for use in an initial access process of ambient Internet of Things communication.

The broadcast information processing method provided in the embodiments of the present application may be executed by a broadcast information processing apparatus. In the embodiments of the present application, the broadcast information processing apparatus executing the broadcast information processing method is taken as an example to illustrate the broadcast information processing apparatus provided in the embodiments of the present application.

In a third aspect, an embodiment of the present application provides a broadcast information processing apparatus applied to a first device, where the first device may be an Internet of Things device. As shown in FIG. 6, the broadcast information processing apparatus 60 may include the following modules:
an acquisition module 601, configured to acquire broadcast information; where
the broadcast information is used to indicate at least one of the following:
access control information;
frequency domain location indication information of a synchronization raster or channel raster;
inventory or paging monitoring indication information;
frequency domain related information of ambient Internet of Things communication; and
rate matching indication information; where
the access control information includes at least one of the following:
cell access indication information, the cell access indication information being used to indicate whether access to a cell is allowed;
an indication of whether to acquire cell access indication information;
an indication of traffic types allowed in an access-permitted cell, the traffic types including device-originated traffic and/or device-terminated traffic;
an indication of device power classes allowed in an access-permitted cell; and
an indication of device types allowed in an access-permitted cell, the device types including at least one device type determined based on an energy storage capacity of an Internet of Things device and a capability of the IoT device to generate radio frequency signals for transmission; and
the frequency domain related information of the ambient Internet of Things communication includes at least one of the following:
an ambient Internet of Things communication bandwidth;
a frequency domain interval between ambient Internet of Things communication and non-ambient Internet of Things communication;
relative frequency domain starting location information of the ambient Internet of Things communication bandwidth; and
frequency hopping indication information of ambient Internet of Things communication.

Optionally, the broadcast information includes at least one of a master information block and physical layer indication information.

Optionally, the broadcast information is carried in at least one of a low-power synchronization signal and a physical broadcast channel.

Optionally, the device-originated traffic includes at least one of the following:
device-originated autonomous traffic; and
device-originated device-terminated triggered traffic.

Optionally, the frequency domain location indication information of a synchronization raster or channel raster satisfies at least one of the following:
the frequency domain location indication information of the synchronization raster or channel raster includes index information of a synchronization raster or index information of a channel raster; and
the frequency domain location indication information of a synchronization raster or channel raster is associated with a deployment mode of ambient Internet of Things.

Optionally, an association relationship between the frequency domain location indication information of the synchronization raster or channel raster and the deployment mode of ambient Internet of Things satisfies at least one of the following:
frequency domain location indication information of a synchronization raster or channel raster exists in in-band deployment mode;
frequency domain location indication information of a synchronization raster or channel raster exists in guard band deployment mode; and
frequency domain location indication information of a synchronization raster or channel raster does not exist in stand-alone deployment mode.

Optionally, the inventory or paging monitoring indication information satisfies at least one of the following:
a transmission period of the inventory or paging monitoring indication information is an integer multiple of a transmission period of the broadcast information;
the inventory or paging monitoring indication information is transmitted at a specific transmission occasion of the broadcast information; and
the inventory or paging monitoring indication information and other information are transmitted in different information blocks, where the other information includes at least one item of information indicated by the broadcast information except the inventory or paging monitoring indication information.

Optionally, in a case that the broadcast information is broadcast information of ambient Internet of Things communication, at least one item of information in the frequency domain related information of the ambient Internet of Things communication is further carried in broadcast information of non-ambient Internet of Things communication.

Optionally, the rate matching indication information is used to indicate information about resources unavailable for ambient Internet of Things communication.

Optionally, the rate matching indication information includes pattern information of unavailable resources;
where the pattern information of unavailable resources indicates at least one of the following:
unavailable symbol information;
unavailable subframe information
unavailable system frame information
unavailable frequency domain information; and
period information of the unavailable resource pattern.

Optionally, the broadcast information is transmitted in at least one information block; where
the at least one information block satisfies at least one of the following:
the at least one information block is separately added with a cyclic redundancy check;
the at least one information block is separately subjected to channel coding;
the at least one information block is separately subjected to scrambling;
the at least one information block is self-decodable;
multiple information blocks occupy different time domain resources;
multiple information blocks occupy different frequency domain resources; and
transmission periodicities of multiple information blocks are the same or different.

Optionally, the apparatus further includes at least one of the following modules:
a first determination module, configured to, in a case that the broadcast information indicates the access control information, determine, based on the access control information, whether access to a cell is allowed, or determine whether to acquire cell access indication information;
a second determination module, configured to, in a case that the broadcast information indicates frequency domain location indication information of the synchronization raster or channel raster, determine, based on the frequency domain location indication information of a synchronization raster or channel raster, a frequency domain location of the broadcast information;
a processing module, configured to, in a case that the broadcast information indicates rate matching indication information, perform data reception and demodulation based on the rate matching indication information;
a third determination module, configured to, in a case that the broadcast information indicates the inventory or paging monitoring indication information, determine, based on the inventory or paging monitoring indication information, at least one of the following:
whether to start monitoring control information in ambient Internet of Things communication, where the control information includes at least one of a paging command, an inventory command, and a selection command; and
whether to acquire inventory or paging grouping indication information.

Optionally, the broadcast information further indicates at least one of the following:
time synchronization information;
cell identification information;
scheduling related information of a first system information block SIB1;
deployment mode information of ambient Internet of Things;
system information SI update indication information; and
Earthquake and Tsunami Warning System ETWS notification information.

Optionally, a change or update period of the broadcast information is greater than or equal to a transmission period of a low-power synchronization signal.

The broadcast information processing apparatus in the embodiments of the present application may be an electronic device, for example, an electronic device with an operating system, or may be a component in an electronic device, such as an integrated circuit or a chip. The electronic device may be a terminal. By way of example, the terminal may include, but is not limited to, the types of the terminal 11 listed above, and this is not specifically limited in this embodiment of the present application.

The broadcast information processing apparatus provided in the embodiments of the present application can implement the processes implemented by the method embodiments of FIG. 2 to FIG. 4, with the same technical effects achieved. To avoid repetition, details are not repeated here.

In a fourth aspect, an embodiment of the present application provides a broadcast information processing apparatus applied to a second device, where the second device may be a network-side device (for example, a base station). As shown in FIG. 7, the broadcast information processing apparatus 70 may include the following modules:
a sending module 701, configured to send broadcast information; where
the broadcast information is used to indicate at least one of the following:
access control information;
frequency domain location indication information of a synchronization raster or channel raster;
inventory or paging monitoring indication information;
frequency domain related information of ambient Internet of Things communication; and
rate matching indication information; where
the access control information includes at least one of the following:
cell access indication information, the cell access indication information being used to indicate whether access to a cell is allowed;
an indication of whether to acquire cell access indication information;
an indication of traffic types allowed in an access-permitted cell, the traffic types including device-originated traffic and/or device-terminated traffic;
an indication of device power classes allowed in an access-permitted cell; and
an indication of device types allowed in an access-permitted cell, the device types including at least one device type determined based on an energy storage capacity of an Internet of Things device and a capability of the IoT device to generate radio frequency signals for transmission; and
the frequency domain related information of the ambient Internet of Things communication includes at least one of the following:
an ambient Internet of Things communication bandwidth;
a frequency domain interval between ambient Internet of Things communication and non-ambient Internet of Things communication;
relative frequency domain starting location information of the ambient Internet of Things communication bandwidth; and
frequency hopping indication information of ambient Internet of Things communication.

Optionally, the broadcast information includes at least one of a master information block and physical layer indication information.

Optionally, the broadcast information is carried in at least one of a low-power synchronization signal and a physical broadcast channel.

Optionally, the device-originated traffic includes at least one of the following:
device-originated autonomous traffic; and
device-originated device-terminated triggered traffic.

Optionally, the frequency domain location indication information of a synchronization raster or channel raster satisfies at least one of the following:
the frequency domain location indication information of the synchronization raster or channel raster includes index information of a synchronization raster or index information of a channel raster; and
the frequency domain location indication information of a synchronization raster or channel raster is associated with a deployment mode of ambient Internet of Things.

Optionally, an association relationship between the frequency domain location indication information of the synchronization raster or channel raster and the deployment mode of ambient Internet of Things satisfies at least one of the following:
frequency domain location indication information of a synchronization raster or channel raster exists in in-band deployment mode;
frequency domain location indication information of a synchronization raster or channel raster exists in guard band deployment mode; and
frequency domain location indication information of a synchronization raster or channel raster does not exist in stand-alone deployment mode.

Optionally, the inventory or paging monitoring indication information satisfies at least one of the following:
a transmission period of the inventory or paging monitoring indication information is an integer multiple of a transmission period of the broadcast information;
the inventory or paging monitoring indication information is transmitted at a specific transmission occasion of the broadcast information; and
the inventory or paging monitoring indication information and other information are transmitted in different information blocks, where the other information includes at least one item of information indicated by the broadcast information except the inventory or paging monitoring indication information.

Optionally, in a case that the broadcast information is broadcast information of ambient Internet of Things communication, at least one item of information in the frequency domain related information of the ambient Internet of Things communication is further carried in broadcast information of non-ambient Internet of Things communication.

Optionally, the rate matching indication information is used to indicate information about resources unavailable for ambient Internet of Things communication.

Optionally, the rate matching indication information includes pattern information of unavailable resources; where
the pattern information of unavailable resources indicates at least one of the following:
unavailable symbol information;
unavailable subframe information
unavailable system frame information
unavailable frequency domain information; and
period information of the unavailable resource pattern.

Optionally, the apparatus further includes:
a mapping module, configured to, in a case that the broadcast information indicates the rate matching indication information, perform resource mapping of ambient Internet of Things communication based on the rate matching indication information.

Optionally, the broadcast information is transmitted in at least one information block; where
the at least one information block satisfies at least one of the following:
the at least one information block is separately added with a cyclic redundancy check;
the at least one information block is separately subjected to channel coding;
the at least one information block is separately subjected to scrambling;
the at least one information block is self-decodable;
multiple information blocks occupy different time domain resources;
multiple information blocks occupy different frequency domain resources; and
transmission periodicities of multiple information blocks are the same or different.

Optionally, the broadcast information further includes at least one of the following:
time synchronization information;
cell identification information;
scheduling related information of a first system information block SIB1;
deployment mode information of ambient Internet of Things;
system information SI update indication information; and Earthquake and Tsunami Warning System ETWS notification information.

Optionally, a change or update period of the broadcast information is greater than or equal to a transmission period of a low-power synchronization signal.

The broadcast information processing apparatus in the embodiments of the present application may be an electronic device, for example, an electronic device with an operating system, or may be a component in an electronic device, such as an integrated circuit or a chip. The electronic device may be a network-side device. By way of example, the network-side device may include, but is not limited to, the types of the network-side device 12 listed above, and this is not specifically limited in this embodiment of the present application.

The broadcast information processing apparatus provided in the embodiments of the present application can implement the processes implemented by the method embodiment of FIG. 5, and with the same technical effects achieved. To avoid repetition, details are not repeated here.

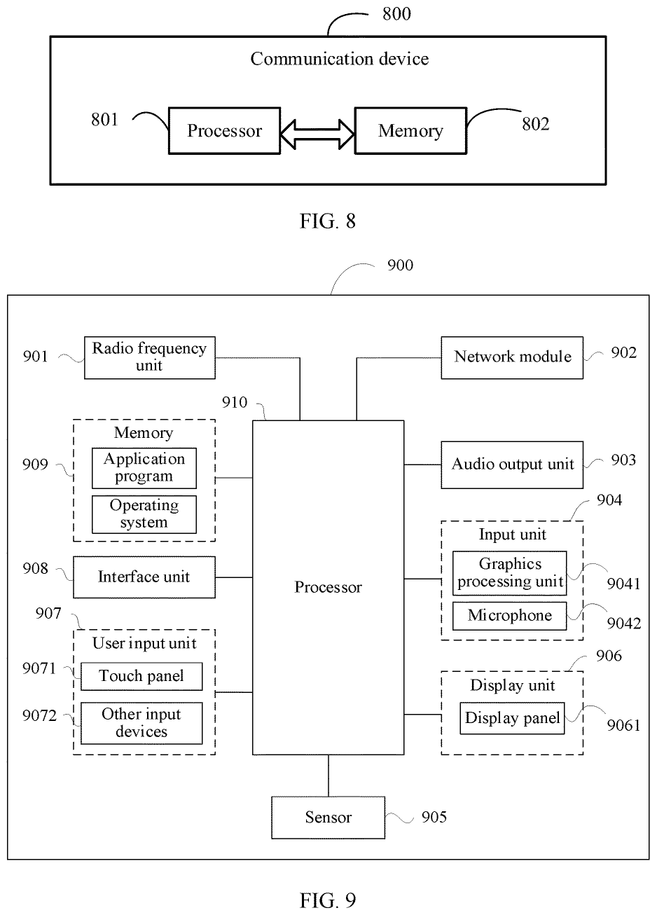

As shown in FIG. 8, an embodiment of the present application further provides a communication device 800, including a processor 801 and a memory 802, where the memory 802 stores a program or an instruction capable of running on the processor 801. For example, when the communication device 800 is a first device, the programs or instruction is executed by the processor 801 to implement the steps of the above embodiments of the broadcast information processing method according to the first aspect, with the same technical effects achieved. When the communication device 800 is a second device, the programs or instruction is executed by the processor 801 to implement the steps of the above embodiments of the broadcast information processing method according to the second aspect, with the same technical effects achieved. To avoid repetition, details are not repeated here.

An embodiment of the present application further provides a terminal, including a processor and a communication interface. The communication interface is coupled to the processor, and the processor is configured to run a program or instruction to implement the steps in the method embodiment as shown in FIG. 2. The terminal embodiment corresponds to the above terminal side method embodiment. All processes and implementations in the above method embodiments are applicable to the terminal embodiment, with the same technical effects achieved. Specifically, FIG. 9 is a schematic diagram of a hardware structure of a terminal implementing the embodiments of the present application.

The terminal 900 includes, but is not limited to at least some of components such as a radio frequency unit 901, a network module 902, an audio output unit 903, an input unit 904, a sensor 905, a display unit 906, a user input unit 907, an interface unit 908, a memory 909, and a processor 910.

Those skilled in the art can understand that the terminal 900 may further include a power supply (such as a battery) for supplying power to various components, and the power supply may be logically connected to the processor 910 through a power management system. In this way, functions such as charge management, discharge management, and power consumption management are implemented by using the power management system. The terminal structure shown in FIG. 9 does not constitute a limitation on the terminal, and the terminal may include more or fewer components than shown in the figure, or combine certain components, or have different component arrangements. Details are not described herein.

It should be understood that in the embodiment of the present application, the input unit 904 may include a graphics processing unit (Graphics Processing Unit, GPU) 9041 and a microphone 9042, and the graphics processor 9041 processes image data of still pictures or videos obtained by an image capture device (such as a camera) in a video capture mode or an image capture mode. The display unit 906 may include a display panel 9061, and the display panel 9061 may be configured in the form of a liquid crystal display, an organic light emitting diode, or the like. The user input unit 907 includes at least one of a touch panel 9071 and other input devices 9072. The touch panel 9071 is also referred to as a touch screen. The touch panel 9071 may include two parts: a touch detection device and a touch controller. The other input devices 9072 may include, but are not limited to, a physical keyboard, function keys (such as volume control keys, switch keys, etc.), a trackball, a mouse, and a joystick. Details are not described herein.

In the embodiment of the present application, after receiving downlink data from a network-side device, the radio frequency unit 901 may transmit the downlink data to the processor 910 for processing; and the radio frequency unit 901 may send uplink data to the network-side device. Generally, the radio frequency unit 901 includes, but is not limited to, an antenna, an amplifier, a transceiver, a coupler, a low noise amplifier, and a duplexer.

The memory 909 may be configured to store software programs or instructions and various data. The memory 909 may mainly include a first storage area for storing programs or instructions and a second storage area for storing data, where the first storage area may store an operating system, an application program or instruction required by at least one function (such as a sound playback function, an image playback function, etc.), and the like. In addition, the memory 909 may include a volatile memory or a non-volatile memory. The non-volatile memory may be a read-only memory (Read-Only Memory, ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (Random Access Memory, RAM), a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDRSDRAM), an enhanced synchronous dynamic random access memory (Enhanced SDRAM, ESDRAM), a synchronous link dynamic random access memory (Synch link DRAM, SLDRAM), and a direct rambus random access memory (Direct Rambus RAM, DRRAM). The memory 909 in the embodiments of the present application includes, but is not limited to, these and any other suitable types of memory.

The processor 910 may include one or more processing units. Optionally, the processor 910 may integrate an application processor and a modem processor. The application processor primarily processes operations involving an operating system, user interface, application program, or the like. The modem processor primarily processes radio communication signals, for example, being a baseband processor. It can be understood that the modem processor may alternatively be not integrated in the processor 910.

The radio frequency unit 901 is configured to acquire broadcast information; where
the broadcast information is used to indicate at least one of the following:
access control information;
frequency domain location indication information of a synchronization raster or channel raster;
inventory or paging monitoring indication information;
frequency domain related information of ambient Internet of Things communication; and
rate matching indication information; where
the access control information includes at least one of the following:
cell access indication information, the cell access indication information being used to indicate whether access to a cell is allowed;
an indication of whether to acquire cell access indication information;
an indication of traffic types allowed in an access-permitted cell, the traffic types including device-originated traffic and/or device-terminated traffic;
an indication of device power classes allowed in an access-permitted cell; and
an indication of device types allowed in an access-permitted cell, the device types including at least one device type determined based on an energy storage capacity of an Internet of Things device and a capability of the IoT device to generate radio frequency signals for transmission; and
the frequency domain related information of the ambient Internet of Things communication includes at least one of the following:
an ambient Internet of Things communication bandwidth;
a frequency domain interval between ambient Internet of Things communication and non-ambient Internet of Things communication;
relative frequency domain starting location information of the ambient Internet of Things communication bandwidth; and
frequency hopping indication information of ambient Internet of Things communication.

Optionally, the broadcast information includes at least one of a master information block and physical layer indication information.

Optionally, the broadcast information is carried in at least one of a low-power synchronization signal and a physical broadcast channel.

Optionally, the device-originated traffic includes at least one of the following:
device-originated autonomous traffic; and
device-originated device-terminated triggered traffic.

Optionally, the frequency domain location indication information of a synchronization raster or channel raster satisfies at least one of the following:
the frequency domain location indication information of the synchronization raster or channel raster includes index information of a synchronization raster or index information of a channel raster; and
the frequency domain location indication information of a synchronization raster or channel raster is associated with a deployment mode of ambient Internet of Things.

Optionally, an association relationship between the frequency domain location indication information of the synchronization raster or channel raster and the deployment mode of ambient Internet of Things satisfies at least one of the following:
frequency domain location indication information of a synchronization raster or channel raster exists in in-band deployment mode;
frequency domain location indication information of a synchronization raster or channel raster exists in guard band deployment mode; and
frequency domain location indication information of a synchronization raster or channel raster does not exist in stand-alone deployment mode.

Optionally, the inventory or paging monitoring indication information satisfies at least one of the following:
a transmission period of the inventory or paging monitoring indication information is an integer multiple of a transmission period of the broadcast information;
the inventory or paging monitoring indication information is transmitted at a specific transmission occasion of the broadcast information; and
the inventory or paging monitoring indication information and other information are transmitted in different information blocks, where the other information includes at least one item of information indicated by the broadcast information except the inventory or paging monitoring indication information.

Optionally, in a case that the broadcast information is broadcast information of ambient Internet of Things communication, at least one item of information in the frequency domain related information of the ambient Internet of Things communication is further carried in broadcast information of non-ambient Internet of Things communication.

Optionally, the rate matching indication information is used to indicate information about resources unavailable for ambient Internet of Things communication.

Optionally, the rate matching indication information includes pattern information of unavailable resources; where
the pattern information of unavailable resources indicates at least one of the following:
unavailable symbol information;
unavailable subframe information
unavailable system frame information
unavailable frequency domain information; and
period information of the unavailable resource pattern.

Optionally, the broadcast information is transmitted in at least one information block; where
the at least one information block satisfies at least one of the following:
the at least one information block is separately added with a cyclic redundancy check;
the at least one information block is separately subjected to channel coding;
the at least one information block is separately subjected to scrambling;
the at least one information block is self-decodable;
multiple information blocks occupy different time domain resources;
multiple information blocks occupy different frequency domain resources; and
transmission periodicities of multiple information blocks are the same or different.

Optionally, the processor 910 is configured to:
in a case that the broadcast information indicates the access control information, determine, based on the access control information, whether access to a cell is allowed, or determine whether to acquire cell access indication information;
in a case that the broadcast information indicates frequency domain location indication information of the synchronization raster or channel raster, determine, based on the frequency domain location indication information of a synchronization raster or channel raster, a frequency domain location of the broadcast information;
in a case that the broadcast information indicates rate matching indication information, perform data reception and demodulation based on the rate matching indication information; and
in a case that the broadcast information indicates the inventory or paging monitoring indication information, determine, based on the inventory or paging monitoring indication information, at least one of the following:
whether to start monitoring control information in ambient Internet of Things communication, where the control information includes at least one of a paging command, an inventory command, and a selection command; and
whether to acquire inventory or paging grouping indication information.

Optionally, the broadcast information further indicates at least one of the following:
time synchronization information;
cell identification information;
scheduling related information of a first system information block SIB1;
deployment mode information of ambient Internet of Things;
system information SI update indication information; and
Earthquake and Tsunami Warning System ETWS notification information.

Optionally, a change or update period of the broadcast information is greater than or equal to a transmission period of a low-power synchronization signal.

It can be understood that for the implementation process of the implementations in the method embodiments, reference may be made to the related description in the method embodiments, with the same or corresponding technical effects achieved. To avoid repetition, details are not be repeated here.

An embodiment of the present application further provides a network-side device, including a processor and a communication interface. The communication interface is coupled to the processor, and the processor is configured to run a program or an instruction to implement the steps of the method embodiment as shown in FIG. 5. The network-side device embodiment corresponds to the above network-side device method embodiment. All processes and implementations in the above method embodiments are applicable to the network-side device embodiment, with the same technical effects achieved.

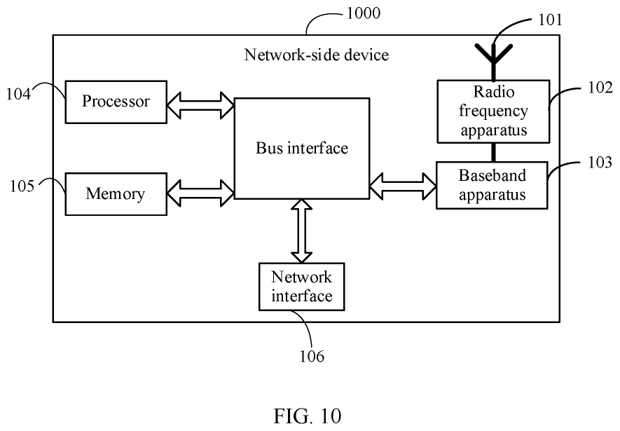

Specifically, an embodiment of the present application further provides a network-side device. As shown in FIG. 10, the network-side device 1000 includes: an antenna 101, a radio frequency apparatus 102, a baseband apparatus 103, a processor 104, and a memory 105. The antenna 101 is connected to the radio frequency apparatus 102. In an uplink direction, the radio frequency apparatus 102 receives information through the antenna 101 and sends the received information to the baseband apparatus 103 for processing. In a downlink direction, the baseband apparatus 103 processes to-be-sent information, and sends the information to the radio frequency apparatus 102; and the radio frequency apparatus 102 processes the received information and then transmits the information by using the antenna 101.

The method executed by the network-side device in the above embodiments may be implemented in the baseband apparatus 103. The baseband apparatus 103 includes a baseband processor.

The baseband apparatus 103, for example, may include at least one baseband board on which multiple chips are disposed. As shown in FIG. 10, one of the chips is, for example, a baseband processor, and connected to the memory 105 through a bus interface to invoke the program in the memory 105 to perform the operations of the network device shown in the above method embodiments.

The network-side device may further include a network interface 106, where the interface is, for example, a common public radio interface (Common Public Radio Interface, CPRI).

Specifically, the network-side device 1000 in this embodiment of the present invention further includes an instruction or program stored on the memory 105 and executable on the processor 104. The processor 104 invokes the instruction or program in the memory 105 to execute methods executed by modules shown in FIG. 7, with the same technical effects achieved. To avoid repetition, details are not repeated here.

An embodiment of the present application further provides a readable storage medium, where a programs or instruction is stored in the readable storage medium, and when the program or instruction is executed by a processor, the processes of the above embodiments of the broadcast information method are implemented, with the same technical effects achieved. To avoid repetition, details are not repeated here.

The processor is the processor in the terminal described in the above embodiments. The readable storage medium includes a computer-readable storage medium, such as a computer read-only memory ROM, a random access memory RAM, a magnetic disk, or an optical disk. In some examples, the readable storage medium may be a non-transitory readable storage medium.

An embodiment of the present application further provides a chip, where the chip includes a processor and a communication interface, the communication interface is coupled to the processor, and the processor is configured to run a program or instruction to implement the processes of the above embodiments of the broadcast information processing method, with the same technical effects achieved. To avoid repetition, details are not repeated here.

It should be understood that the chip mentioned in this embodiment of the present application may also be referred to as a system-level chip, a system chip, a chip system, a system on chip, or the like.

An embodiment of the present application further provides a computer program/program product, where the computer program/program product is stored in a storage medium, and the computer program/program product is executed by at least one processor to implement the processes of the above embodiments of the broadcast information processing method, with the same technical effects achieved. To avoid repetition, details are not repeated here.

An embodiment of the present application further provides a broadcast information processing system including a first device and a second device. The first device may be configured to execute the steps of the broadcast information processing method according to the first aspect above, and the second device may be configured to execute the steps of the broadcast information processing method according to the second aspect above.

It should be noted that in this document, terms “comprise”, “include”, or any other variants thereof are intended to cover non-exclusive inclusion, so that a process, method, article, or apparatus including a series of elements not only includes those elements, but also includes other elements not explicitly listed, or further includes elements inherent to such process, method, article, or apparatus. When there are no more restrictions, an element defined by the statement “including a . . . ” does not exclude the existence of other identical elements in the process, method, article, or apparatus including the element. In addition, it should be noted that the scope of the methods and apparatuses in the embodiments of the present application is not limited to performing functions in the order shown or discussed, but can also include performing functions in a substantially simultaneous manner or in a reverse order, depending on the functions involved. For example, the described method may be executed in an order different from the described order, and steps may be added, omitted, or combined. In addition, features described with reference to some examples may be combined in other examples.

Through the description of the above embodiments, those skilled in the art can clearly understand that the methods in the above embodiments can be implemented by means of computer software product plus a necessary general hardware platform, and of course can also be implemented by hardware. The computer software product is stored in a storage medium (such as ROM, RAM, magnetic disk, and optical disk), including several instructions to cause a terminal or network-side device to execute the methods described in various embodiments of the present application.

The embodiments of the present application have been described above with reference to the accompanying drawings. However, the present application is not limited to the above specific embodiments. The above specific embodiments are merely illustrative rather than restrictive. Under the enlightenment of the present application, those of ordinary skill in the art can develop implementations in many forms without departing from the purpose of the present application and the scope protected by the claims, and these implementations all fall within the protection of the present application.

1. A broadcast information processing method, wherein the method comprises:
acquiring, by a first device, broadcast information;
wherein the broadcast information is used to indicate at least one of the following:
access control information;
frequency domain location indication information of a synchronization raster or channel raster;
inventory or paging monitoring indication information;
frequency domain related information of ambient Internet of Things communication; and
rate matching indication information; wherein
the access control information comprises at least one of the following:
cell access indication information, the cell access indication information being used to indicate whether access to a cell is allowed;
an indication of whether to acquire cell access indication information;
an indication of traffic types allowed in an access-permitted cell, the traffic types comprising device-originated traffic and/or device-terminated traffic;
an indication of device power classes allowed in an access-permitted cell; and
an indication of device types allowed in an access-permitted cell, the device types comprising at least one device type determined based on an energy storage capacity of an Internet of Things device and a capability of the IoT device to generate radio frequency signals for transmission; and
the frequency domain related information of the ambient Internet of Things communication comprises at least one of the following:
an ambient Internet of Things communication bandwidth;
a frequency domain interval between ambient Internet of Things communication and non-ambient Internet of Things communication;
relative frequency domain starting location information of the ambient Internet of Things communication bandwidth; and
frequency hopping indication information of ambient Internet of Things communication.

2. The method according to claim 1, wherein the broadcast information comprises at least one of a master information block and physical layer indication information.

3. The method according to claim 1, wherein the broadcast information is carried via at least one of a low-power synchronization signal and a physical broadcast channel.

4. The method according to claim 1, wherein the frequency domain location indication information of a synchronization raster or channel raster satisfies at least one of the following:
the frequency domain location indication information of the synchronization raster or channel raster comprises index information of a synchronization raster or index information of a channel raster; and
the frequency domain location indication information of a synchronization raster or channel raster is associated with a deployment mode of ambient Internet of Things.

5. The method according to claim 4, wherein an association relationship between the frequency domain location indication information of the synchronization raster or channel raster and the deployment mode of ambient Internet of Things satisfies at least one of the following:
frequency domain location indication information of a synchronization raster or channel raster exists in in-band deployment mode;
frequency domain location indication information of a synchronization raster or channel raster exists in guard band deployment mode; and
frequency domain location indication information of a synchronization raster or channel raster does not exist in stand-alone deployment mode.

6. The method according to claim 1, wherein the inventory or paging monitoring indication information satisfies at least one of the following:
a transmission period of the inventory or paging monitoring indication information is an integer multiple of a transmission period of the broadcast information;
the inventory or paging monitoring indication information is transmitted at a specific transmission occasion of the broadcast information; and
the inventory or paging monitoring indication information and other information are transmitted in different information blocks, wherein the other information comprises at least one item of information indicated by the broadcast information except the inventory or paging monitoring indication information.

7. The method according to claim 1, wherein, in a case that the broadcast information is broadcast information of ambient Internet of Things communication, at least one item of information in the frequency domain related information of the ambient Internet of Things communication is further carried in broadcast information of non-ambient Internet of Things communication.

8. The method according to claim 1, wherein the rate matching indication information is used to indicate information about resources unavailable for ambient Internet of Things communication.

9. The method according to claim 8, wherein the rate matching indication information comprises pattern information of unavailable resources;
wherein the pattern information of unavailable resources indicates at least one of the following:
unavailable symbol information;
unavailable subframe information
unavailable system frame information
unavailable frequency domain information; and
periodicity information of the unavailable resource pattern.

10. The method according to claim 1, wherein the broadcast information is transmitted in at least one information block; wherein
the at least one information block satisfies at least one of the following:
the at least one information block is separately added with a cyclic redundancy check;
the at least one information block is separately subjected to channel coding;
the at least one information block is separately subjected to scrambling;
the at least one information block is self-decodable;
multiple information blocks occupy different time domain resources;
multiple information blocks occupy different frequency domain resources; and
transmission periodicities of multiple information blocks are the same or different.

11. The method according to claim 1, wherein the method further comprises at least one of the following steps:
in a case that the broadcast information indicates the access control information, determining, by the first device based on the access control information, whether access to a cell is allowed, or determining whether to acquire cell access indication information;
in a case that the broadcast information indicates the frequency domain position location indication information of a synchronization raster or channel raster, determining, by the first device based on the frequency domain location indication information of a synchronization raster or channel raster, a frequency domain location of broadcast information;
in a case that the broadcast information indicates the rate matching indication information, performing, by the first device, data reception and demodulation based on the rate matching indication information; and
in a case that the broadcast information indicates the inventory or paging monitoring indication information, determining, by the first device based on the inventory or paging monitoring indication information, at least one of the following:
whether to start monitoring control information in ambient Internet of Things communication, wherein the control information comprises at least one of a paging command, an inventory command, and a selection command; and
whether to acquire inventory or paging grouping indication information.

12. The method according to claim 1, wherein a change or update period of the broadcast information is greater than or equal to a transmission period of a low-power synchronization signal.

13. A broadcast information processing method, wherein the method comprises:
sending, by a second device, broadcast information;
wherein the broadcast information is used to indicate at least one of the following:
access control information;
frequency domain location indication information of a synchronization raster or channel raster;
inventory or paging monitoring indication information;
frequency domain related information of ambient Internet of Things communication; and
rate matching indication information; wherein
the access control information comprises at least one of the following:
cell access indication information, the cell access indication information being used to indicate whether access to a cell is allowed;
an indication of whether to acquire cell access indication information;
an indication of traffic types allowed in an access-permitted cell, the traffic types comprising device-originated traffic and/or device-terminated traffic;
an indication of device power classes allowed in an access-permitted cell; and
an indication of device types allowed in an access-permitted cell, the device types comprising at least one device type determined based on an energy storage capacity of an Internet of Things device and a capability of the IoT device to generate radio frequency signals for transmission; and
the frequency domain related information of the ambient Internet of Things communication comprises at least one of the following:
an ambient Internet of Things communication bandwidth;
a frequency domain interval between ambient Internet of Things communication and non-ambient Internet of Things communication;
relative frequency domain starting location information of the ambient Internet of Things communication bandwidth; and
frequency hopping indication information of ambient Internet of Things communication.

14. The method according to claim 13, wherein the frequency domain location indication information of a synchronization raster or channel raster satisfies at least one of the following:
the frequency domain location indication information of the synchronization raster or channel raster comprises index information of a synchronization raster or index information of a channel raster; and
the frequency domain location indication information of a synchronization raster or channel raster is associated with a deployment mode of ambient Internet of Things.

15. The method according to claim 14, wherein an association relationship between the frequency domain location indication information of the synchronization raster or channel raster and the deployment mode of ambient Internet of Things satisfies at least one of the following:
frequency domain location indication information of a synchronization raster or channel raster exists in in-band deployment mode;
frequency domain location indication information of a synchronization raster or channel raster exists in guard band deployment mode; and
frequency domain location indication information of a synchronization raster or channel raster does not exist in stand-alone deployment mode.

16. The method according to claim 13, wherein the inventory or paging monitoring indication information satisfies at least one of the following:
a transmission period of the inventory or paging monitoring indication information is an integer multiple of a transmission period of the broadcast information;
the inventory or paging monitoring indication information is transmitted at a specific transmission occasion of the broadcast information; and
the inventory or paging monitoring indication information and other information are transmitted in different information blocks, wherein the other information comprises at least one item of information indicated by the broadcast information except the inventory or paging monitoring indication information.

17. The method according to claim 13, wherein the rate matching indication information is used to indicate information about resources unavailable for ambient Internet of Things communication.

18. The method according to claim 13, wherein the method further comprises:
in a case that the broadcast information indicates the rate matching indication information, performing, by the second device, resource mapping of ambient Internet of Things communication based on the rate matching indication information.

19. A communication device, comprising a processor and a memory, wherein the memory stores a program or an instruction capable of running on the processor, and the program or instruction, when executed by the processor, implements a broadcast information processing method, comprising:
acquiring broadcast information;
wherein the broadcast information is used to indicate at least one of the following:
access control information;
frequency domain location indication information of a synchronization raster or channel raster;
inventory or paging monitoring indication information;
frequency domain related information of ambient Internet of Things communication; and
rate matching indication information; wherein
the access control information comprises at least one of the following:
cell access indication information, the cell access indication information being used to indicate whether access to a cell is allowed;
an indication of whether to acquire cell access indication information;
an indication of traffic types allowed in an access-permitted cell, the traffic types comprising device-originated traffic and/or device-terminated traffic;
an indication of device power classes allowed in an access-permitted cell; and
an indication of device types allowed in an access-permitted cell, the device types comprising at least one device type determined based on an energy storage capacity of an Internet of Things device and a capability of the IoT device to generate radio frequency signals for transmission; and
the frequency domain related information of the ambient Internet of Things communication comprises at least one of the following:
an ambient Internet of Things communication bandwidth;
a frequency domain interval between ambient Internet of Things communication and non-ambient Internet of Things communication;
relative frequency domain starting location information of the ambient Internet of Things communication bandwidth; and
frequency hopping indication information of ambient Internet of Things communication.

20. A communication device, comprising a processor and a memory, wherein the memory stores a program or an instruction capable of running on the processor, and when the program or instruction is executed by the processor, the steps of the broadcast information processing method according to claim 13 are implemented.
